(19) United States
(12) Patent Application Publication
(10) Pub. No.: US 2026/0244415 A1
(43) Pub. Date: Aug. 20, 2026

(54) CONTEXT-AWARE ARTIFICIAL INTELLIGENCE SYSTEM FOR WEB INTERFACE EDITING

(71) Applicant: Wix.com Ltd., Tel Aviv (IL)

(72) Inventors: Oz GOLAN, Gan Yavne (IL); David Yedidya FRIEDENBERG, Binyamina (IL)

(21) Appl. No.: 19/541,432

(22) Filed: Feb. 17, 2026

Related U.S. Application Data
(60) Provisional application No. 63/760,643, filed on Feb. 20, 2025.
(60) Provisional application No. 63/933,056, filed on Dec. 7, 2025.

(51) Int. Cl. G06F 8/38; G06F 8/34; H04L 51/02

(52) U.S. Cl. CPC G06F 8/38; G06F 8/34; H04L 51/02

(57) ABSTRACT

A context-aware AI system for editing interface elements of a site includes a visual interface that receives user interaction and presents visual output; a conversational interface that receives natural language instructions and presents natural language messages; a context recognition module that identifies elements, computes a respective score for each element based on semantic similarity between the instructions and element's metadata and select elements having scores satisfying a criterion; a context management module that maintains an active editing context identifying elements and data associated with them, and updates the active editing context in response to an operation received via the visual interface or via the conversational interface; an interface assistant that generates editing operations based on the natural language instructions; a visual reaction module that applies the editing operations on the visual interface; and a conversational reaction module for displaying natural language messages on the conversational interface.

### CROSS REFERENCE TO RELATED APPLICATIONS

This application claims priority from U.S. provisional patent application No. 63/760,643 filed Feb. 20, 2025, and U.S. provisional patent application No. 63/933,056 filed Dec. 7, 2025, both of which are incorporated herein by reference.

### FIELD OF THE INVENTION

The present disclosure relates to interface editing systems within Website Building Systems (WBS) generally, and more particularly to context-aware artificial intelligence system for assisting users in editing interface elements via a visual interface and a conversational interface.

### BACKGROUND OF THE INVENTION

Website building and content management systems have become increasingly sophisticated, allowing users to create and edit complex websites (and other applications) without extensive coding knowledge. These systems typically provide visual interfaces for designing and modifying web elements (including their design and layout) and chat-based interfaces for more advanced customization and troubleshooting.

However, integrating these visual and chat-based interfaces may present challenges in terms of user experience and efficiency. Users frequently encounter difficulties in precisely communicating their intentions when attempting to edit specific web page elements through a conversational interface. This lack of clarity may lead to misunderstandings, errors, and a time-consuming back-and-forth process between the user and the system.

Furthermore, some existing systems may not maintain context awareness during editing. As users switch their focus between different elements or sections of a website, the system may lose track of the current focus, requiring users to specify which element they are referring to repeatedly. This constant need for clarification may significantly slow the editing process and lead to user frustration (e.g., “Make the button red-no, not that one; the other button.”).

Another challenge in current web editing systems is the limitation in handling multiple contexts simultaneously. Users often need to make related changes across different elements or sections of a website. Still, existing systems may not provide efficient ways to manage these multiple contexts without losing track of the overall editing flow.

While artificial intelligence has been increasingly incorporated into web development tools, some systems may not accurately interpret user intentions, especially when dealing with ambiguous requests or complex design requirements. This may result in suggested changes that do not align well with the overall design and functionality of the website.

Lack of clarity during an editing session leads to confusion about the focus of the discussion and its broader context, making it challenging for users to align their intentions with the adjustments being made. As a result, the process becomes unnecessarily time-consuming, requiring additional back-and-forth to clarify details and make precise changes. This inefficiency not only extends the time required to adjust elements but also diminishes the overall intuitiveness of the system, leaving users frustrated and less likely to feel confident in their ability to achieve their desired outcomes.

As web technologies continue to evolve, there is a growing need for more intuitive, context-aware editing systems that may bridge the gap between visual interfaces and natural language interactions. Such systems would ideally be able to intelligently recognize and maintain context, handle multiple editing scenarios simultaneously, and provide accurate, design-aligned suggestions to users. Any references herein to existing or known systems are provided solely for context and are not an admission that such systems constitute prior art.

### SUMMARY OF THE PRESENT INVENTION

There is provided in accordance with an embodiment of the present invention, a context-aware artificial intelligence (AI) system for editing visual interface elements of a site. The system includes at least one memory storing instructions, at least one processor communicatively coupled to said memory; a visual interface, a conversational interface, a context recognition module, a context management module, a interface assistant, a visual reaction module and a conversational reaction module. The processor is communicatively coupled to the memory. The visual interface is configured to support presentation of the visual interface elements, reception of user interaction, and presentation of visual output; The conversational interface is configured to support reception of one or more natural language instructions, and presentation of one or more natural language messages. The context recognition module is configured to identify interface elements within a scope of the site, compute a respective score for each of the interface elements based at least on semantic similarity between the natural language instructions and metadata associated with each of the interface elements, and select one or more candidate interface elements having respective scores that satisfy a configurable selection criterion. The context management module is configured to maintain an active editing context identifying at least one candidate interface element and context data associated with the candidate interface element, and to update the active editing context in response to a visual operation received via the visual interface or in response to natural language instructions received via the conversational interface. The interface assistant is configured to generate one or more planned editing operations related to the active editing context based on the natural language instructions. The visual reaction module is configured to apply the planned editing operations to modify at least one visual interface element of the site and to display a visual indication associated with the active editing context on the visual interface. The conversational reaction module is configured to display one or more conversational natural language messages on the conversational interface, wherein all the system modules include instructions stored in the memory and executable by the processor.

Moreover, in accordance with an embodiment of the present invention, the system also includes one or more large language models (LLMs) configured to generate at least part of the planned editing operations responsive to prompts generated based on the natural language instructions and at least one of: an active editing context or context data, where the one or more LLMs are pretrained, trained offline, or both, and where data for training the LLMs is derived from one or more of: (i) interaction data captured during one or more editing sessions of the user, including a current editing session, and stored for subsequent offline training; (ii) a plurality of editing sessions of the user across multiple sites and (iii) a plurality of editing sessions of multiple users.

Further, in accordance with an embodiment of the present invention, the interface assistant also includes a prompt generator configured to construct the prompts for the LLMs, the prompt being constructed to elicit a response indicative of one or more candidate interface elements and one or more associated actions or selectable options, and a response handler configured to receive a response from the one or more LLMs and to validate that an operation identifier in the response corresponds to a supported set of available operations and that associated parameters conform to expected data types, value ranges, and constraints, verify that any interface element referenced by the response exists within an active editing context, and responsive to (a) a validation result indicating uncertainty or (b) a destructive operation, request user confirmation prior to executing the one or more planned editing operations.

Still further, in accordance with an embodiment of the present invention, the prompt generator utilizes user interaction data that includes user input, user interaction history and user feedback; page and context data comprising that includes the at least one active interface element, the scope and a structured representation of a page of the site; and visual and structural data that include visual information and capabilities and properties of interface elements, for generating the prompt.

Additionally, in accordance with an embodiment of the present invention, the context recognition module also includes a current user interaction analyzer configured to infer an editing context based on interactions of the user with the visual interface and the conversational interface; a historical user interaction analyzer configured to infer an editing context based on historical interaction data of the user; a site information extraction module configured to infer an editing context based on a structure and content of a web page of the site; and a context prioritization module configured to evaluate one or more inferred contexts according to their relevance to the user.

Moreover, in accordance with an embodiment of the present invention, the current user interaction analyzer also includes a graphical selection module configured to analyze user interactions with the visual interface and to identify a first set of interface elements selected by the user, and a chat information extraction module configured to analyze the natural language instructions and to identify a second set of interface elements referenced by the natural language instructions.

Further, in accordance with an embodiment of the present invention, the historical user interaction analyzer also includes a current site editing history module configured to analyze historical editing interactions of the user with the site across prior editing sessions; other sites' editing history module configured to analyze historical editing interactions of the user with one or more other sites; and a common interaction patterns module configured to identify common interaction patterns of multiple users editing a plurality of sites.

Still further, in accordance with an embodiment of the present invention, the system also includes a user feedback module configured to collect feedback associated with system-generated natural language output from the user, and where the interface assistant is further configured to utilize the feedback to determine or refine one or more planned editing operations.

Still further, in accordance with an embodiment of the present invention, the visual interface is further configured to apply one or more visual indicators to visually distinguish selected interface elements, the visual indicators including one or more of: border highlighting, background overlay, glow effects, annotation labels and dimming of surrounding elements.

Additionally, in accordance with an embodiment of the present invention, responsive to a selection of an interface element made by the user through the conversational interface, the visual interface is configured to apply a visual indicator to selected interface element; and responsive to a selection of an interface element made by the user through the visual interface, the conversational interface is configured to apply a corresponding indicator to a representation of the selected interface element.

There is provided in accordance with an embodiment of the present invention a method for editing visual interface elements of a site, the method includes supporting presentation of the visual interface elements in a visual interface, reception of user interaction, and presentation of visual output; supporting reception of one or more natural language instructions in a conversational interface and presentation of one or more natural language messages; identifying a plurality of interface elements within a scope of the site and computing a respective score for each of the plurality of interface elements based at least on semantic similarity between the one or more natural language instructions and metadata associated with each of the plurality of interface elements, and selecting one or more candidate interface elements having respective scores that satisfy a configurable selection criterion; maintaining an active editing context identifying at least one candidate interface element and context data associated with the at least one candidate interface element, and updating the active editing context in response to a visual operation received via the visual interface or in response to natural language instructions received via the conversational interface; generating one or more planned editing operations related to the active editing context based on the one or more natural language instructions; applying the one or more planned editing operations to modify at least one visual interface element of the site and to displaying a visual indication associated with the active editing context on the visual interface; and displaying one or more conversational natural language messages on the conversational interface.

Additionally, in accordance with an embodiment of the present invention, the method also includes generating prompts based on the one or more natural language instructions and at least one of: an active editing context or context data, and providing the prompts to one or more large language models (LLMs), where the one or more LLMs are pretrained, trained offline, or both, and wherein data for training the one or more LLMs is derived from one or more of: (i) interaction data captured during one or more editing sessions of the user, including a current editing session, and stored for subsequent offline training; (ii) a plurality of editing sessions of the user across multiple sites; and (iii) a plurality of editing sessions of multiple users.

Additionally, in accordance with an embodiment of the present invention, the step of generating prompts also includes constructing the prompts for the one or more LLMs to elicit a response indicative of one or more candidate interface elements and one or more associated actions or selectable options; receiving a response from the one or more LLMs, validating that an operation identifier in the response corresponds to a supported set of available operations and that associated parameters conform to expected data types, value ranges, and constraints; verifying that any interface element referenced by the response exist within an active editing context; and requesting user confirmation prior to executing the or more planned editing operations if a validation result indicating uncertainty or an existence of a destructive operation.

Furthermore, in accordance with an embodiment of the present invention, the method also includes utilizing user interaction data that includes user input, user interaction history and user feedback; page and context data that includes the at least one active interface element, the scope and a structured representation of a page of the site; and visual and structural data that includes visual information, capabilities and properties of interface elements, for generating the prompt.

Still further, in accordance with an embodiment of the present invention, the method also includes inferring an editing context based on interactions of the user with the visual interface and the conversational interface; historical interaction data of the user; a structure and content of a web page of the site; and relevance to the user.

Moreover, in accordance with an embodiment of the present invention, the method also includes analyzing user interactions with the visual interface using a graphical selection and identifying a first set of interface elements selected by the user; and analyzing the one or more natural language instructions and identifying a second set of interface elements referenced by the one or more natural language instructions.

Additionally, in accordance with an embodiment of the present invention, analyzing historical interaction data includes analyzing historical editing interactions of the user with the site across prior editing sessions; analyzing historical editing interactions of the user with one or more other sites; and identifying common interaction patterns of multiple users editing a plurality of sites.

Further, in accordance with an embodiment of the present invention, the method also includes collecting feedback associated with system-generated natural language output from the user and utilizing the feedback to determine or refine one or more planned editing operations.

Still further, in accordance with an embodiment of the present invention, the method also includes applying one or more visual indicators to visually distinguish selected interface elements, the visual indicators include one or more of: border highlighting, background overlay, glow effects, annotation labels and dimming of surrounding elements.

Moreover, in accordance with an embodiment of the present invention, the method also includes applying a visual indicator to selected interface element in the visual interface in response to a selection of an interface element made by the user through the conversational interface; and applying a corresponding indicator to a representation of the selected interface element in the conversational interface in response to a selection of an interface element made by the user through the visual interface.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic block diagram of a context-aware artificial intelligence (AI) system for editing interface elements using a visual interface and a conversational interface, in accordance with some embodiments.

FIG. 2 is a schematic block diagram of a context recognition module, in accordance with some embodiments.

FIG. 3 is a schematic block diagram of a current user interaction analyzer, in accordance with some embodiments.

FIG. 4 is a schematic block diagram of a historical user interaction analyzer, in accordance with some embodiments.

FIG. 5 is a schematic block diagram of an interface assistant including a prompt generator and a response handler, in accordance with some embodiments.

FIG. 6 is a schematic diagram of information used to generate prompts based on user input and context, in accordance with some embodiments.

FIG. 7 is a flow diagram of a process for context-aware conversational and visual interface editing, in accordance with some embodiments.

FIG. 8 is an example user interface state in which an interface assistant is invoked without an element selection and a page-level or site-level context is established, in accordance with some embodiments.

FIG. 9 is an example user interface state in which an element is selected, and a corresponding context indicator is presented via the interface assistant, in accordance with some embodiments.

FIG. 10 is an example user interface state in which a section-level context is established, and a corresponding context indicator is presented via the interface assistant, in accordance with some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, certain methods, procedures, and components have not been described in detail so as not to obscure the present invention.

Applicant has realized that, in the context of visual and web-based application editing, some traditional methods fail to provide intuitive mechanisms for users to directly specify, select, and modify interface elements within the editing environment, which can result in confusion, inefficiency, and frustration when users attempt to perform precise modifications or convey design intent. Additionally, existing AI-assisted editing tools often lack sufficient contextual awareness to accurately interpret user requests, thereby leading to misinterpretations and repeated clarification exchanges between the user and the system.

Applicant has realized that assisting users in editing web and visual interface elements may be improved by combining visual and conversational interfaces with a context-aware artificial intelligence system, wherein the artificial intelligence system is configured to supply contextual information to the conversational interface during an editing session.

Applicant has further realized that such a system may be deployed across a wide range of computing environments and interaction modalities, including, but not limited to, web-based editing environments, mobile application development tools, desktop software design platforms, and other visual editing contexts. While the discussion below refers primarily to conversational interfaces, such references should be construed to encompass additional categories of user interaction, including, for example, questionnaire-based, gesture-based, biometric, or hybrid interfaces.

The context-aware artificial intelligence system may be configured to perform one or more of the following functions during an editing session: provide mechanisms for combining explicit context specification with implicit context inference, thereby enabling an intuitive way for users to specify and modify interface elements during a conversational session without requiring explicit element selection, such as by drag-and-drop, point-and-click, or other manual operations; maintain contextual information associated with one or more elements currently in focus during the editing session, and derive user intent within the conversational interface based on the maintained contextual information; and handle multiple editing scenarios concurrently, while generating accurate suggestions that are aligned with design constraints, layout consistency, and user intent.

The context-aware artificial intelligence system may enable users to define the editing context through multiple input modalities, including direct interaction with interface elements (e.g., clicking, tapping, or selecting elements within the visual interface), natural language requests submitted via a conversational interface, or a combination of both. The artificial intelligence component may recognize and establish context based on user actions, written instructions, or both, and may maintain awareness of the active context throughout the editing process, even as users transition between different elements or sections. In addition, the system may provide clear visual cues or indicators to represent the active editing context, ensuring that users understand which element or section is currently being edited or referenced.

By combining context definition, intelligent context management, and visual context indication, the system creates a more intuitive editing experience that may require fewer computational operations, may reduce user interaction overhead (e.g., repeated manual selection actions), may reduce errors in web editing, and may reduce ambiguity in user-AI communication, thereby streamlining the overall editing workflow. This integrated approach may improve interpretation of user requests by leveraging maintained context and, when needed, disambiguation interactions, and may support the generation of relevant AI-assisted suggestions, resulting in a more efficient and user-friendly editing environment.

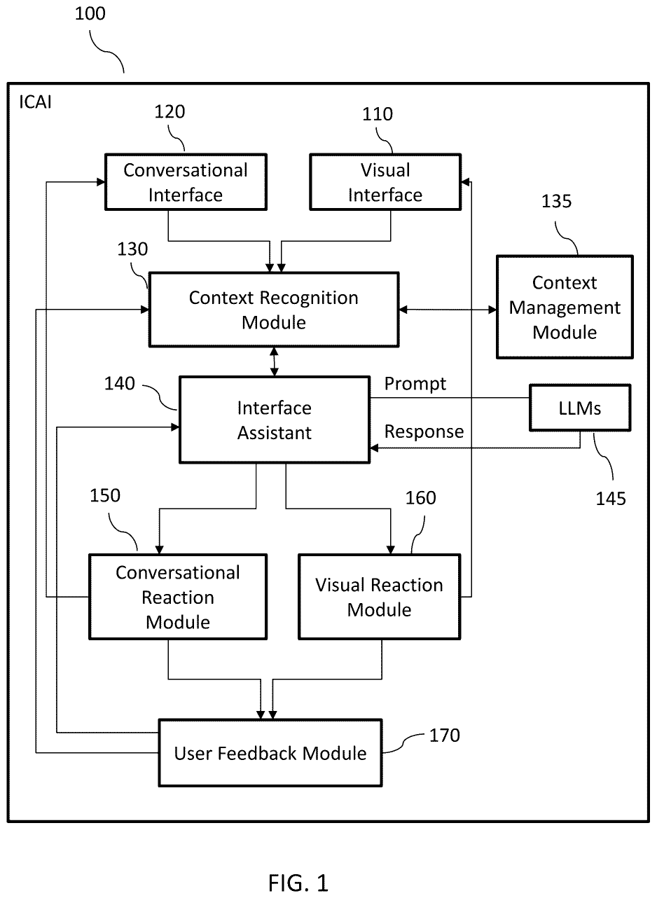

FIG. 1, to which reference is now made, is a schematic illustration of an In Context Artificial Intelligence system (ICAI) 100, constructed and implemented in accordance with an embodiment of the present invention. ICAI 100 may reduce ambiguity in editing operations by providing context information during user interactions. It may capture explicit user selections of interface elements; analyze natural language inputs to infer intended target elements; and display visual indicators that identify the currently active editing context. ICAI 100 comprises a Visual Interface 110; a Conversational Interface 120; a Context Recognition Module 130; a Context Management Module 135; an Interface Assistant 140; one or more large language models (LLMs) 145; a Conversational Reaction Module 150; a Visual Reaction Module 160 and a User Feedback Module 170.

Visual Interface 110 may comprise any graphical user interface that enables a user to define or refine contextual information by directly manipulating on-screen elements, wherein such manipulation may be performed using a pointing device, including, for example, a mouse, trackpad, stylus, or touch input, and using interaction techniques such as point and click, drag and drop, tapping, hovering, or gesture-based interactions, to indicate one or more interface elements with which the user intends to work.

As used herein, the terms “visual interface” and “graphical user interface” may be used interchangeably to refer to the interface through which a user visually selects, inspects, and edits interface elements.

As used herein, “site” includes a website, a web application, and other digitally rendered interactive experiences having interface elements editable via a structured representation (e.g., a DOM, view hierarchy, or scene graph). As used herein, a “module” may be implemented using hardware, software (including processor-executable instructions stored in memory), or a combination thereof, and may be distributed across multiple computing devices.

In web-based embodiments, interface elements may correspond to nodes in a document object model (DOM) and planned editing operations may comprise modifying DOM properties, attributes, or associated style definitions. In other embodiments, interface elements may correspond to nodes in a view hierarchy, scene graph, or analogous structured representation, and planned editing operations may comprise modifying properties of such nodes.

Visual Interface 110 may be configured to dynamically display interface elements as they are created, modified, or selected, and to provide a clear and persistent indication of an active context corresponding to one or more interface elements currently in focus, if any are selected. Visual Interface 110 may further capture and process user interactions with such elements, track changes made to the elements and dynamically update the display to reflect such changes in real time.

Visual Interface 110 may update dynamically in response to user actions using, for example, Hover Preview, Confidence Visualization, Animated Transitions or any other visual indications.

For example, Hover Preview may be employed in disambiguation mode when multiple candidate elements are identified, such that hovering over a candidate temporarily highlights the corresponding element in the visual interface. Confidence Visualization may be used when a possible context is identified with moderate confidence, displaying a confidence indicator, such as a partially filled circle or a color gradient from yellow to green, to signal uncertainty and invite user confirmation. Animated Transitions may be applied when the context changes, for instance, when a user selects a different element, causing the visual indicator to smoothly transition from the previous context to the new context, for example by fading out the old highlight while fading in the new one, thereby assisting the user in tracking the change. In some embodiments, when disambiguation is triggered, ICAI 100 may highlight a subset of candidate elements and may present a clarification prompt via Conversational Interface 120 to obtain user input selecting an intended target element.

Conversational Interface 120 may comprise a user interface that enables a user to interact with a system through natural language dialogue, including, for example, text or speech, and may provide natural and intuitive means for creating, modifying, or editing interface components. Conversational Interface 120 may receive natural language input from the user and display system-generated natural language output.

In one embodiment, Conversational Interface 120 may be implemented using a chatbot or other conversational mechanism configured to receive and present user inputs, interpret them and facilitate editing of the components.

In some embodiments, Conversational Interface 120 and Interface Assistant 140 may reduce the number of user interactions required for editing operations and may improve collaboration among users participating in an editing workflow.

In some embodiments, ICAI 100 may be used in a collaborative editing environment in which a plurality of users concurrently view and/or modify a common interface. In such embodiments, ICAI 100 may maintain per-user active context state information and, subject to collaboration permissions and sharing settings, may optionally share at least a portion of the context state among authorized collaborators. For example, when a first user selects an element or otherwise changes an active editing context, ICAI 100 may transmit a context change event to one or more additional client devices such that the additional client devices display an indication of the first user's focus (e.g., a label identifying that the first user is editing a particular section or element) and/or display the resulting modification after an operation is applied.

In some embodiments, Conversational Interface 120 may present collaboration information including, without limitation, proposed operations, confirmations, approvals, comments, and/or an audit trail of applied operations, thereby enabling collaborators to coordinate changes and, in some embodiments, reduce the likelihood of conflicting edits.

Context Recognition Module 130 may be configured to identify and interpret an active editing context and one or more surrounding elements based on user interactions and inputs, enabling ICAI 100 to provide context-aware assistance. By accurately recognizing the editing context, Context Recognition Module 130 may ensure that ICAI 100 determines user intent from the active editing context and generates relevant suggestions, aligns its responses and actions with the user's needs and reflects those in the operations of Conversational Interface 120 and Visual Interface 110. Maintaining a context in this manner may make the editing process more intuitive and improve efficiency, for example by reducing repeated context specification by the user and, in some embodiments, reducing repeated context interpretation steps (e.g., via caching or reuse of previously computed context signals), thereby reducing required computational resources. The structure and functionality of Context Recognition Module 130 are described in greater detail herein below.

Context Management Module 135 may be configured to track and maintain the active editing context, including selected on-screen elements, and to dynamically adjust the context as the user interacts with the interface, ensuring that Context Recognition Module 130 remains aligned with the user's current focus. Context Management Module 135 may track user transitions between different interface elements or sections to reduce ambiguity between Conversational Interface 120 and Visual Interface 110 during editing operations, and to maintain continuous awareness of the active editing context throughout the session. By intelligently managing context across user interactions and interface transitions, Context Management Module 135 may enable accurate interpretation of user actions and supports the generation of relevant AI-assisted suggestions.

In some embodiments, Context Management Module 135 may maintain an active context record that includes one or more of: a scope identifier, one or more active element identifiers, a selection history, and one or more timestamps associated with user interactions. In some embodiments, updates to the active context record may generate a context change event that may be consumed by other modules to synchronize a context indicator in Conversational Interface 120 and a visual indication in Visual Interface 110.

Context Management Module 135 may communicate with Context Recognition Module 130 and work together to create a more intuitive, requiring fewer computational operations, and editing experience by maintaining and updating the active editing context across user interactions. In some embodiments, maintaining the active context may reduce repeated context specification and may reduce ambiguity in user-AI communication during editing operations. In one embodiment, Context Recognition Module 130 and Context Management Module 135 may be implemented as a single component.

Interface Assistant 140 comprises a context-aware artificial intelligence system for assisting users in editing interface elements through visual and conversational interfaces. Interface Assistant 140 may be configured to analyze user interactions, intent, and system state and to deliver relevant suggestions and actions. Interface Assistant 140 may operate in conjunction with LLMs 145 to recognize and interpret user intent and provide context-aware editing suggestions. Interface Assistant 140 may be further configured to utilize natural language processing (NLP), computer vision, and additional machine learning techniques to understand user input and generate design recommendations.

In some embodiments, Interface Assistant 140 may comprise specialized AI agents configured for different element types, including an image processing agent configured to handle image-related editing operations, a layout agent configured to handle container and section modifications, and a content agent configured to handle text and media content editing.

The structure and functionality of Interface Assistant 140 are described in greater detail below.

Interface Assistant 140 may communicate with one or more Large Language Models (LLMs) 145, which may be configured to process natural language inputs, including voice and text, and to generate corresponding editing operations. LLM 145 may be pretrained and/or trained offline using data from multiple users and/or from a specific user across multiple editing sessions. In some embodiments, interaction data captured during a current editing session may be stored for subsequent offline training and/or used as part of the prompt/context supplied to LLM 145 during the current editing session.

In some embodiments, training data for the one or more LLMs 145 comprises records generated from editing sessions, the records including (i) a structured representation of an editing environment (e.g., a portion of a DOM, view hierarchy, or scene graph), (ii) a user instruction, (iii) an identified target element or active editing context, and (iv) an operation representation describing one or more applied editing operations and parameters. The records may be pre-processed to remove or obfuscate personally identifiable information and may be aggregated across users subject to privacy configuration, applicable law and user's rights. In some embodiments, the one or more LLMs 145 may be fine-tuned using supervised learning on instruction-to-operation pairs, optionally combined with preference-based training or reinforcement learning from feedback using validation outcomes and/or user confirmations as signals. Inference embodiments may include executing the model on a client device, on a remote server system, or in a hybrid configuration, and may include caching of context embeddings or partial prompt components to reduce latency.

Conversational Reaction Module 150 may be configured to provide conversational feedback to the user in Conversational Interface 120. For example, Conversational Interface 120 may display a context indicator showing the element type and identifier (e.g., “Button: ‘Submit’”), the hierarchical location of the element (e.g., “Header>Navigation>Submit Button”), a thumbnail or icon representing the element, and an option to clear or change the context (e.g., a “×” button to deselect the element).

Visual Reaction Module 160 may be configured to provide visual indications of the active editing context to the user and apply the changes in Visual Interface 110. The visual indicators may allow users to clearly identify and verify which element(s) are subject to, or will be affected by, editing operations.

In one embodiment, when a single interface element constitutes the active editing context, the module may apply one or more visual indicators to enhance user awareness. Such indicators may include, for example, border highlighting, in which a colored border (e.g., 2-4 pixels wide) is rendered around the perimeter of the element, with the color distinct from the interface's color scheme (e.g., bright blue, orange, or magenta) and the border optionally solid, dashed, or animated (e.g., pulsing opacity or moving dashes); background overlay, in which a semi-transparent colored overlay (e.g., 20-40% opacity) is applied to the element's background while preserving the visibility of its content; glow effects, in which a shadow or halo extends several pixels beyond the element's boundaries; annotation labels, such as a small label or badge positioned near the element (e.g., at the top-right corner) displaying text or an icon indicating the element is selected for editing; and dimming of surrounding elements, in which elements outside the active context are rendered with reduced opacity (e.g., 50-70% of normal) or with a gray overlay to create visual contrast and highlight the active element.

In another embodiment, when multiple interface elements are simultaneously part of the active editing context, the module may distinguish them using techniques such as consistent highlighting, where all elements in the context receive the same visual treatment (e.g., all have blue borders) to indicate a common selection group; numbered indicators, where the element is labeled with a number (e.g., “1”, “2”, “3”) to allow users to reference specific elements in conversational instructions (e.g., “change the color of element 2 to red”); connecting lines or brackets, in which visual connectors such as lines, brackets, or grouping boxes indicate that multiple elements are part of a single editing operation; and color coding, in which different elements may receive different colored indicators if they represent distinct roles in the editing operation (e.g., source element in green, target element in blue for a copy operation).

In some embodiments, Visual Reaction Module 160 may be configured to provide accessibility-compliant context indication behaviors. For example, when a client device, operating system, or browser indicates that an accessibility mode is enabled (including, without limitation, a high-contrast mode), Visual Reaction Module 160 may adapt one or more visual indicators (e.g., indicator colors, patterns, border thickness, animation cadence, and/or use of non-color cues) to facilitate satisfaction of applicable accessibility guidelines (for example, Web Content Accessibility Guidelines (WCAG) 2.1 Level AA) and to maintain perceptibility for users with color-vision deficiencies.

In some embodiments, when an active editing context changes, ICAI 100 may generate an accessibility announcement for assistive technologies. For example, a screen reader announcement may identify the newly active element and optionally its hierarchical location (e.g., “Active context changed to Submit button in header”). In some embodiments, ICAI 100 may enable keyboard navigation among elements in the active editing context (and/or among candidate elements presented during disambiguation), such that navigation input (e.g., Tab, Shift-Tab, arrow keys, or other shortcuts) may cause Context Recognition Module 130 and Context Management Module 135 to update the active context and may cause Visual Reaction Module 160 to update the corresponding visual indicator.

In some embodiments, ICAI 100 may be deployed in virtual reality (VR) and/or augmented reality (AR) editing environments. In such embodiments, the active editing context indicator may comprise three-dimensional highlighting effects applied to a selected object or interface element, including, without limitation, a glowing outline, a halo, a floating label, or an anchored callout rendered in a 3D scene.

In some embodiments, ICAI 100 may provide non-visual cues associated with an active context. For example, ICAI 100 may output spatial audio cues (e.g., a brief tone rendered from the direction of the selected element) and/or haptic feedback via a controller or wearable device when an active editing context changes. In some embodiments, Context Recognition Module 130 may utilize gaze tracking and/or head pose tracking to infer which element the user is attending to, and Context Management Module 135 may update the active editing context based on the inferred attention.

In some embodiments, gaze tracking provides a gaze point or gaze ray that can be mapped to a rendered coordinate space of the visual interface. The system may perform a hit-test between the gaze point (or an intersection of the gaze ray) and bounding boxes of interface elements and may select a nearest interface element within a threshold distance as a gaze-indicated candidate element. In some embodiments, gaze-indicated candidates may be used as additional signals for context recognition, for example by increasing a relevance score for candidates intersecting the gaze point or by narrowing a scope to elements within a gaze-centered region.

In further embodiments, Visual Reaction Module 160 may provide synchronized indication across interfaces, coordinating with Conversational Interface 120 (e.g., chat panel) to present consistent context information.

In one embodiment, bidirectional highlighting may be employed such that when the user hovers over, focuses on, taps, or otherwise selects the context indicator in Conversational Interface 120 (i.e., the chat panel), the corresponding element in Visual Interface 110 is highlighted, and conversely, when the user hovers over, focuses on, taps, or otherwise selects an element in Visual Interface 110, its representation in Conversational Interface 120 is highlighted. This synchronized visual feedback between Visual Interface 110 and Conversational Interface 120 may help maintain consistency between interfaces and enhance user awareness of the active editing context.

In one embodiment suitable for web-based editing environments, Visual Reaction Module 160 may implement one or more visual indicators by dynamically applying one or more style definitions to document object model (DOM) elements corresponding to the active editing context. For example, the system may apply one or more CSS classes (and/or inline style attributes) to one or more DOM elements in the active editing context and may remove such classes (and/or attributes) when an element exits the active editing context.

In such embodiments, a client-side event-driven module (for example, implemented in JavaScript) may subscribe to context change events produced by Context Recognition Module 130 and/or Context Management Module 135 and, in response to a context change event: (i) remove indicator classes from previously highlighted elements; (ii) apply indicator classes to newly active elements; (iii) update a context indicator displayed within Conversational Interface 120; and (iv) trigger animations and/or transitions associated with a context change.

In an alternative embodiment suitable for native, desktop, or non-browser environments, Visual Reaction Module 160 may render one or more visual indicators using platform-specific user interface (UI) frameworks and may optionally render highlights via overlay views, overlay layers, or equivalent constructs that render an indicator without modifying the underlying interface element. In some embodiments, Visual Reaction Module 160 may utilize graphics APIs to render indicator shapes or effects (including, without limitation, Core Graphics, Canvas, OpenGL, or equivalents).

User Feedback Module 170 may be configured to collect user feedback associated with generated suggestions and to adjust the subsequent suggestions based on the collected feedback, thereby enhancing the effectiveness and personalization of the editing experience. In one embodiment, personalization may be further improved by analyzing user inputs, interaction patterns, and feedback over time, and by adapting system behavior to individual user needs and preferences.

User feedback may be collected through one or more feedback mechanisms, including, for example, rating systems that enable users to assess the accuracy, relevance, or usefulness of system-generated suggestions, free-form input mechanisms that allow users to provide qualitative comments, clarifications, or improvement suggestions, and error reporting mechanisms configured to capture information related to incorrect, incomplete, or undesired system responses.

User Feedback Module 170 may improve the accuracy and effectiveness of Context Recognition Module 130; Interface Assistant 140 and Conversational Interface 120 by incorporating analyzed user feedback and adjusting one or more corresponding algorithms based on the analyzed feedback.

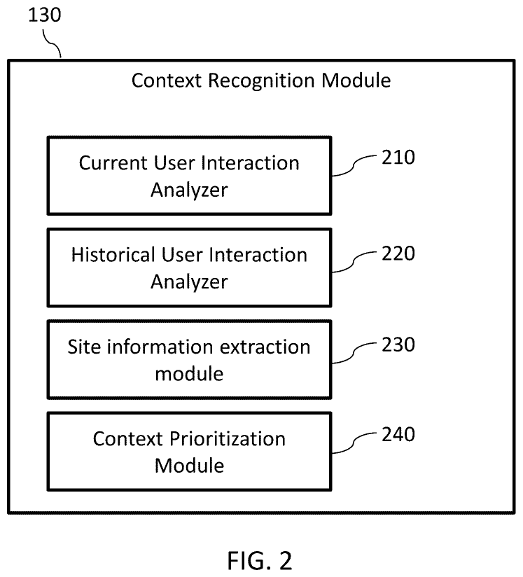

FIG. 2, to which reference is now made, is a schematic illustration of Context Recognition Module 130, constructed and operative in accordance with an embodiment of the present invention. Context Recognition Module 130 may be configured to infer context based on current user interaction, historical user interaction and the underlying site or interface structure and may utilize various tools, including, but not limited to, computer vision, interaction tracking, natural language analysis, user behavior analysis, eye tracking, gesture recognition, or sensor data, to determine context from selected images or other visual elements.

Context Recognition Module 130 may be configured to track and update the current context based on multiple input modalities, such as direct interaction with interface elements (e.g., clicking, tapping, or selecting) through Visual Interface 110, natural language requests submitted through a Conversational Interface 120, or a combination of both. Context Recognition Module 130 may assist in providing visual indicators or cues to represent the active context, ensuring that users understand which element or section is currently being edited or referenced.

In one embodiment, Context Recognition Module 130 may be configured to combine multiple sources of contextual information, including current user interaction, historical user interactions and interface (e.g., site) structure, to accurately infer the user's context. The inferred context may then be used to guide subsequent operations or generate suggestions that are relevant, precise, and aligned with the user's intentions.

In some embodiments, Context Recognition Module 130 may be configured to incorporate user-defined context definitions. For example, ICAI 100 may provide a configuration interface (via Visual Interface 110, Conversational Interface 120, or both) that enables a user to define one or more custom contexts associated with a particular site, web application, page type, template, section, container, workflow stage, or other scope. A user-defined context definition may identify, for example, a set of element types, identifiers, attributes, tags, hierarchical patterns, and/or structural relationships that the user commonly edits within the associated scope.

In some embodiments, a user-defined context definition may be stored as one or more rules, templates, profiles, and/or learned representations and may be applied as an additional signal when computing candidate relevance scores and selecting an active editing context. For example, Context Prioritization Module 240 may adjust a relevance score for a candidate element based on whether the candidate element matches a user-defined context associated with the current page, template, or section, thereby improving context recognition accuracy for recurring workflows.

In some embodiments Context Recognition Module 130 may compute the context using semantic similarity computed by encoding a user instruction and element metadata such as type, identifier, contained text, attributes, style properties, structural location and the like using a language model such as a transformer-based model, and calculating a similarity score (such as cosine similarity) between the resulting embeddings. In some embodiments, the similarity score may be scaled or normalized for use with predefined thresholds.

Context Recognition Module 130 comprises a Current User Interaction Analyzer 210; a Historical User Interaction Analyzer 220; a Site Information Extraction module 230; and a Context Prioritization Module 240.

Current User Interaction Analyzer 210 may be configured to analyze user interactions with the Visual Interface 110 and Conversational Interface 120 to identify specific elements or sections that are in focus or otherwise engaged by the user. Current User Interaction Analyzer 210 may employ algorithms that process interactions (e.g., clicks, selections, drags, taps, or other input gestures) to determine the specific web or interface elements the user is interacting with or attending to at a given time.

Historical User Interaction Analyzer 220 may be configured to infer context from the history of user interactions. Historical User Interaction Analyzer 220 may collect a list of recently active contexts, to enable the user to quickly switch back to a previous context by clicking on it.

Historical User Interaction Analyzer 220 may leverage the user's visual editing, selection, and interaction history to interpret the intended target of a user instruction and enable Context Recognition Module 130 to determine the component the user is referring to.

For example, a user may alternate between editing components A and B, where component A is of type AA and component B is of type BB. If the user selects component A but subsequently issues an instruction that corresponds to elements of type BB rather than AA, the system may determine, based on the user's prior interactions and editing patterns, that the user is now referring to component B.

Site information extraction module 230 may be configured to infer context from the surrounding elements, structure, and content of the web page. The inferred context may also include additional metadata regarding the currently selected editing component. Site information extraction module 230 may further be configured to extract, organize, and provide the structure and content of the web site, including site-level structure and metadata, keywords, tags, attributes, and custom fields, an identification of the currently edited page, section, or container, elements in focus, and surrounding elements within the same section and in adjacent sections.

Context Prioritization Module 240 may be configured to prioritize contexts based on their relevance and the user's focus, particularly in situations where multiple contexts are simultaneously applicable. By ranking contexts according to importance and user engagement, Context Prioritization Module 240 may ensure that the most relevant context is used to guide operations, interpret user actions, and provide the most accurate state to Interface Assistant 140.

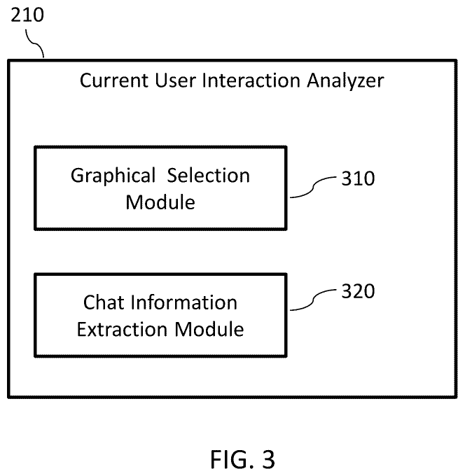

FIG. 3, to which reference is now made, is a schematic illustration of Current User Interaction Analyzer 210, constructed and operative in accordance with an embodiment of the present invention. Current User Interaction Analyzer 210 may be configured to analyze all user interactions with the currently edited interface and determine the specific elements or sections that are currently in focus. Current User Interaction Analyzer 210 comprises a Graphical Selection Module 310 and a Chat Information Extraction Module 320.

Graphical Selection Module 310 may be configured to analyze user interactions with the user interface (UI) (e.g., clicks, selections, and drags) and determine the specific elements or sections that are in focus.

Chat Information Extraction Module 320 may comprise a natural language processing (NLP) module configured to process natural language inputs, including but not limited to text messages and voice commands, and extract user intent, identifying the corresponding target elements to which the input pertains, and determining the actions to be performed on those elements.

Chat Information Extraction Module 320 may utilize a computer vision tool and/or a tool that analyzes interface code to identify one or more candidate target elements when the user provides an image during the chat session via Conversational Interface 120. In some embodiments, the system may correlate a visual region in the image with one or more interface elements using rendered screenshots and associated bounding box coordinates and/or element identifiers and may request user confirmation when multiple candidates match.

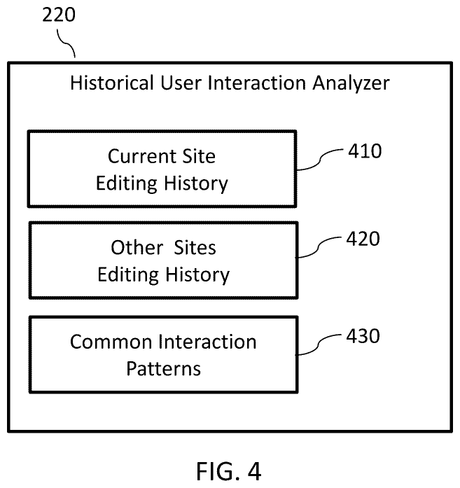

FIG. 4, to which reference is now made, is a schematic illustration of Historical User Interaction Analyzer 220, constructed and operative in accordance with an embodiment of the present invention. Historical User Interaction Analyzer 220 comprises a Current Site Editing History module 410, Other Sites Editing History module 420 and Common Interaction Patterns module 430.

Current Site Editing History module 410 may be configured to analyze historical editing interactions of the user with the site across prior editing sessions in order to identify interface elements or sections that previously received user focus. Such analysis may include prior selections, modifications, navigation actions, and visual or conversational indications, and may be used to derive persistent focus patterns of the user and contextual relevance for subsequent operations.

Other Sites Editing History module 420 may be configured to analyze historical editing interactions of the user currently editing the site across one or more other sites previously created or edited by that user, in order to identify cross-site editing behaviors, recurring patterns, preferences or recurring focus behaviors or tendencies. Such analysis may include prior selections, modifications, navigation actions, and visual or conversational edit operations, and may be used to derive persistent focus patterns preferences, or recurring focus behaviors that are independent of any single site.

Common Interaction Patterns module 430 may be configured to identify common interaction patterns and provide aggregated and anonymized interaction examples from multiple users editing sites. Common interaction patterns may be identified for example, if many users working on interfaces based on a particular template frequently edit certain types of elements in response to certain types of instructions. This pattern information may be used to improve context scoring for similar scenarios. It may be noted that Common Interaction Patterns module 430 may apply privacy protections, including for example anonymization and aggregation, and may be configured to facilitate compliance with applicable data protection requirements, subject to deployment configuration and applicable laws and regulations.

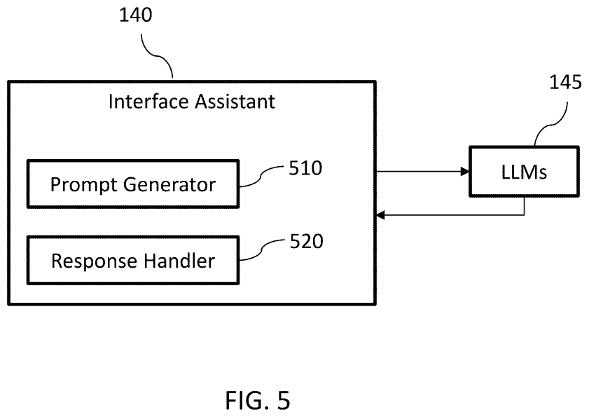

FIG. 5, to which reference is now made, is a schematic illustration of Interface Assistant 140, constructed and operative in accordance with an embodiment of the present invention. Interface Assistant 140 comprises a Prompt Generator 510 and a Response Handler 520. Interface Assistant 140 may be configured to use one or more LLMs 145 to analyze user interactions, intent, and system state and deliver relevant suggestions and actions.

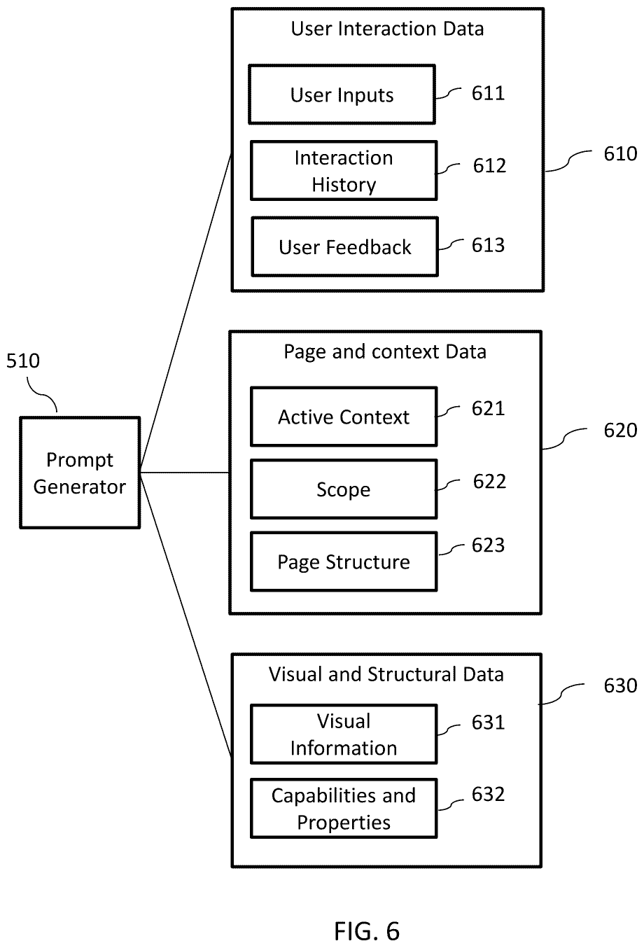

Prompt Generator 510 may be configured to construct a prompt for LLM 145 to generate a response indicative of one or more identified objects and one or more associated actions or selectable options. Prompt Generator 510 may construct the text comprising the prompt based on multiple types of information as is detailed in FIG. 6.

Response Handler 520 may be configured to receive the response from LLM 145, validate it and initiate relevant graphical and conversational actions. Graphical actions may include highlighting one or more elements and/or change the appearance of one or more elements and conversational actions may be displaying possible available options to the user in the conversation.

The validation may include verifying that an operation identifier corresponds to a supported set of available operations, that any associated parameters conform to expected data types, value ranges, and constraints, and that any confidence score associated with the operation (if present) is within a defined range, for example between 0.0 and 1.0. In some embodiments, the system may compute a confidence score based on one or more system-derived signals, such as relevance score margins, validation results, constraint satisfaction, and/or historical success rates, and may treat any confidence value provided by the LLM as advisory. In some embodiments, the system may apply a confidence threshold such that, when confidence is below a predefined threshold (or when validation checks indicate uncertainty), the system may request user confirmation before applying the operation, prompt the user for clarification, or present one or more alternative interpretations of the operation.

Response Handler 520 may perform one or more additional safety checks to ensure reliable and predictable behavior. These safety checks may include verifying that any interface elements referenced by the operation exist within the editing environment, thereby detecting potential hallucinations or invalid references, ensuring that the operation targets elements within an active editing scope, and requiring explicit user confirmation for operations that are destructive or that introduce significant structural changes to the interface.

Upon successful validation and completion of the safety checks, Response Handler 520 may create a set of operations by translating the high-level response into executable interface modifications. For graphical interface, in the case of a web-based interface, this may include generating and executing client-side code to modify document object model properties or style attributes, while in native or desktop applications, the system may invoke appropriate application programming interfaces (APIs) to update user interface elements accordingly. For conversational interface, this may include presenting proposed operations to the user, suggesting one or more possible actions derived from the interpreted intent, or providing alternative options when ambiguity is detected.

In one embodiment, Response Handler 520 may translate high-level editing operations, generated from user input and contextual analysis, into executable instructions suitable for the target interface. These instructions may take the form of code snippets, API calls, or other machine-interpretable commands that directly modify interface elements, properties, or layouts.

Response Handler 520 may request user confirmation prior to executing an operation, particularly when the operation is associated with lower confidence, affects multiple elements, or involves potentially destructive changes. In addition, Response Handler 520 may prompt the user for clarification, refinement, or additional input, and may dynamically update the proposed operations or recommendations based on the user's responses, thereby enabling an interactive and guided editing workflow.

In some embodiments, Response Handler 520 may support multi-step operations in response to complex user instructions that imply multiple editing actions. For such instructions, Response Handler 520 may decompose the instruction into a plurality of sub-instructions and process the resulting operations sequentially, ensuring that the operation is correctly interpreted and applied in the intended order.

In other embodiments, Response Handler 520 may generate multiple operations and apply the operations collectively, for example as a batch or transactional update.

In further embodiments, Response Handler 520 may employ an iterative refinement approach in which operations are applied incrementally, with intermediate results presented to the user through Conversational Interface 120 or Visual Interface 110 and optional user confirmation obtained before proceeding with subsequent operations. This multi-step handling enables ICAI 100 to manage complex editing requests while maintaining user control, transparency, and accuracy.

In some embodiments, Response Handler 520 may further support rollback and error recovery mechanisms in connection with the execution of generated operations. For example, prior to applying an operation or a group of operations, Response Handler 520 may store a snapshot of the affected interface state, enabling reversal of one or more changes if an error is detected, a validation step fails, or the user withdraws confirmation. If an operation cannot be completed successfully, Response Handler 520 may automatically revert the interface to a previous consistent state and notify the user through Conversational Interface 120.

In addition, Response Handler 520 may present corrective suggestions, alternative operations, or recovery options, and may resume execution from a last confirmed operation in the case of multi-step editing workflows. These rollback and recovery capabilities may improve robustness, maintain interface consistency, and preserve user trust during the editing session.

FIG. 6, to which reference is now made, is a schematic illustration of the information that may be used by Prompt Generator 510, in one embodiment of the present invention. Prompt Generator 510 may construct the text comprising the prompt to encapsulate information relevant to accurately interpret and execute the user's instruction and may use information derived, without limitations, from User Interaction Data 610, Page and Context Data 620, and Visual and Structural Data 630.

Prompt Generator 510 may utilize any combination of information extracted from these sources, together with any other accessible information, to improve the accuracy, relevance, and personalization of its operations which may collectively enable the system to accurately interpret user intent and provide context-aware assistance.

User Input and Interaction Data 610 comprises raw User Inputs 611, that may comprise text commands (e.g., “make the button red”), voice commands, or gestures; Interaction History 612, that may comprise recent context, previous instructions, recent element selections, recent editing operations and their outcomes, and User Feedback 613 on previous suggestions or ratings of system outputs, to support interpretation of user intentions and personalization of the editing experience.

Page and Context Data 620 comprises Active Context 621, including the identification of the type of the currently focused element (e.g., “button”), the element identifier (e.g., “submit-button-1”), the element properties that are relevant to the instruction include styling (e.g., current color, font, size, position) content (current text, image source), structural properties (current parent container, sibling elements), and associated metadata such as attributes described in CSS classes.

Page and Context Data 620 further comprises Scope 622, such as page or screen identifiers, container or section hierarchies, and related elements within the same logical group or container.

Page and Context Data 620 further comprises Page Structure 623 that may be represented in a simplified form, such as a portion of the DOM or view hierarchy surrounding the active context, to provide a model of the editing environment and support context-aware operations. Page Structure 623 may be provided as a JavaScript Object Notation (JSON) structure or indented text representation showing element types, IDs, and nesting.

Page Structure 623 may further comprise the corresponding editing operations available for the elements in the page such as “change color,” “resize,” or “move,” “change_text”, “add_element”, “delete_element” including any required parameters, valid values, and constraints (e.g., “color values are validated according to an applicable style specification or rendering framework”).

Visual and Structural Data 630 comprises Visual Information 631 associated with the active context element(s), including rendered images or screenshots and bounding box coordinates. Visual and Structural Data 630 may further include structural relationships among elements, such as neighboring elements within the same or adjacent sections, and environmental or device-related information, such as viewport dimensions, screen resolution, and input modality (e.g., mouse, touch, stylus), to enhance the accuracy and relevance of context-aware editing operations. Visual and Structural Data 630 may further include capabilities and properties 632 of interface elements, such as supported operations, required parameters, allowable value ranges, and constraints.

In one embodiment, Prompt Generator 510 may be implemented as a set of prompt templates associated with a corresponding element of the site, and Prompt Generator 510 may select and apply a relevant template according to the determined context.

The following paragraphs describe an example implementation of a prompt generated by Prompt Generator 510 when a user entered the text “make the button red” in Conversational Interface 120.

“You are an AI assistant helping a user edit a user interface. The user is currently editing the following element:
Element Type: button
Element ID: submit-button-1
Current Properties:
(a) background-color: blue
(b) color: white
(c) font-size: 14px
(d) text: “Submit”
(e) position: (100, 200)

Available Operations:
(a) change_color(property, value): Change a color property (background-color, color, border-color)
(b) change_text(new_text): Change the button text
(c) resize(width, height): Change dimensions
(d) move(x, y): Change position

User Instruction: “make the button red”
Generate a structured, machine-readable response (for example, in JavaScript Object Notation (JSON) or another structured format) with the following structure:

```
{
  “operation”: “<operation_id>”,
  “parameters”: { “<param_name>”: “<value>” },
  “confidence”: <0.0-1.0>,
  “explanation”: “<explanation>”
}
```

For example:

```
{
  ″operation″: ″change_color″,
  ″parameters″: { ″property″: ″background-color″, ″value″: ″red″ },
  ″confidence″: 0.83,
  ″explanation″: ″Change the button background color from blue to red.″
}”
```

Alternative embodiments may use different prompt structures, including (i) Few-shot prompting with examples of instruction-operation pairs; (ii) Chain-of-thought prompting that asks the LLM to reason through the instruction before generating the operation; and (iii) Multi-turn dialogue where the LLM asks clarifying questions before generating the operation

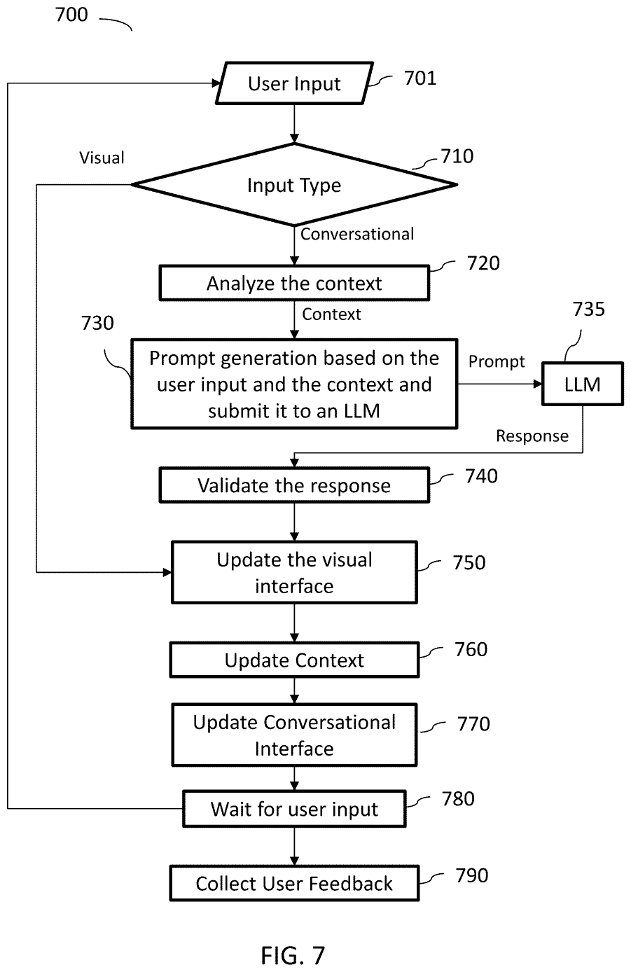

FIG. 7, to which reference is now made, is a schematic illustration of a flow 700 that may be implemented by ICAI 100 in accordance with an embodiment of the present invention.

In step 701 ICAI 100 may receive an input from the user during the editing session. In step 710, ICAI 100 may determine the functionality according to the input type. If the input type is conversational ICAI 100 may continue to step 720 where Context Recognition Module 130 may evaluate the current context with respect to user action and other parameters including the user's historical interaction, the site structure and the like. In step 730, Interface Assistant 140 may create a prompt using the user input, the context and other parameters and provide it in step 735 to LLM 145, that may provide the generated response.

In step 740, ICAI may validate the response and generate one or more operations in response to the output received from LLM 145. In step 750, Visual Reaction Module 160 may update the graphical user interface and highlight the elements that are now perceived to be in focus.

In step 760, ICAI 100 may update the context and in step 770 Conversational Reaction Module 150 may update the conversational interface and display possible operation and suggestions to the user. In step 780 ICAI 100 may wait for user's input and in step 790 User Feedback Module 170 may receive and process user feedback associated with previously performed operations.

It may be appreciated by the person skilled in the art that the steps shown in flow 700 are not intended to be limiting and that the flow may be practiced with more or less steps, or with a different sequence of steps, or any combination thereof.

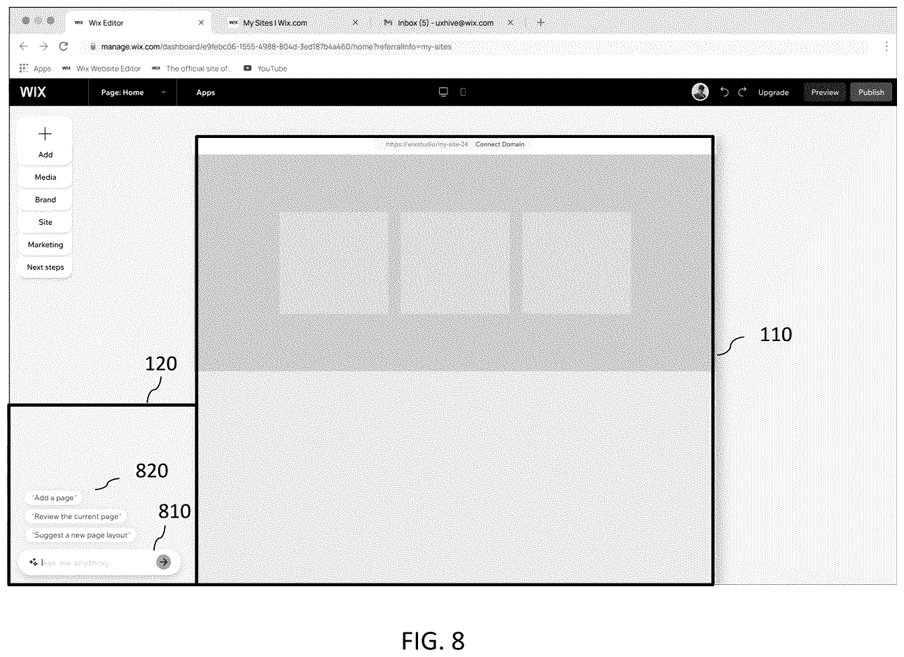

FIGS. 8-10 depict exemplary user interface states following execution of one or more editing operations.

In FIG. 8 the user of ICAI 100 (e.g., site/web application developer) clicks on conversation input field 810 in Conversational Interface 120, without selecting any element on Visual Interface 110. Interface Assistant 140 may determine that no interface element is currently selected and, accordingly, establish the active context at a page or site level. Interface Assistant 140 may display text 820 on Conversational Interface 120, with the options available when no interface is selected in Visual Interface 110. The options in this case are “Add a page”, “Review the current page” and “Suggest a new page layout”.

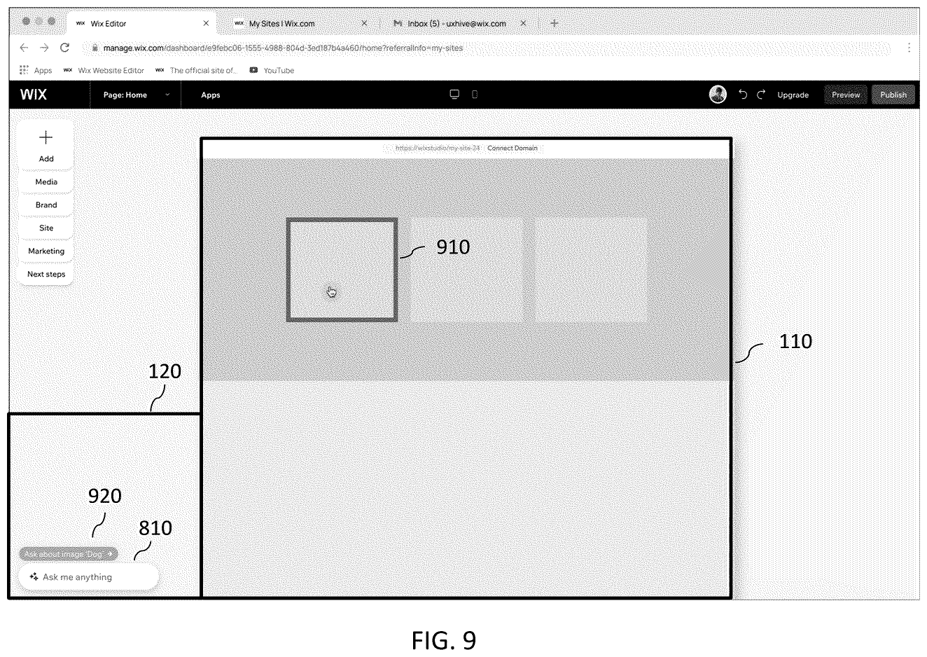

In FIG. 9, the user clicks on item 910 on Visual Interface 110, and Conversational Interface 120, may display text 920 (e.g., “Ask about image ‘Dog’”) responsive to Interface Assistant 140 determining an updated active editing context, and may provide the updated context to Conversational Reaction Module 150, which updates Conversational Interface 120.

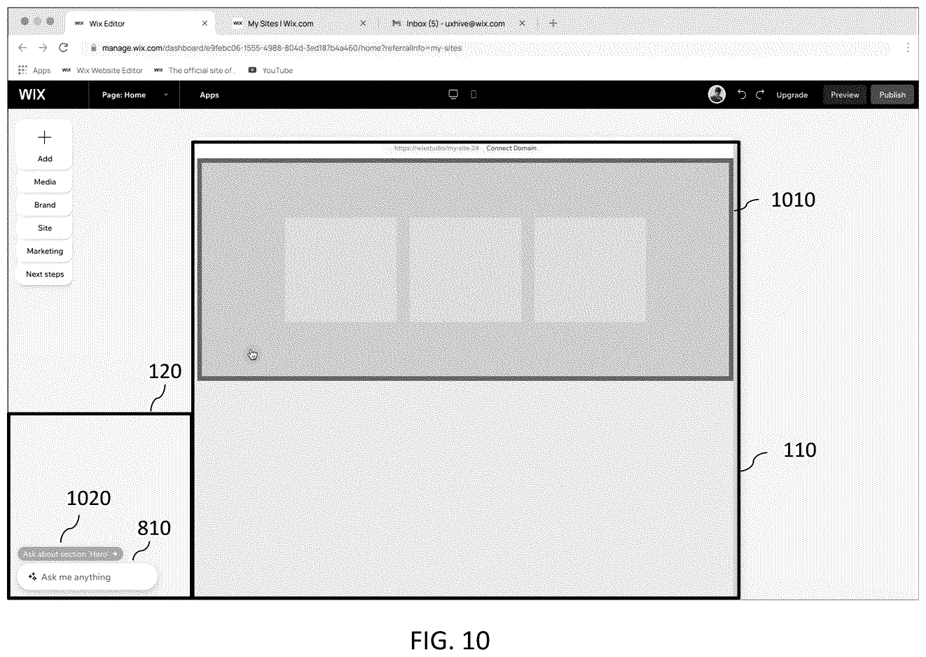

In FIG. 10, the user clicks on section 1010 on Visual Interface 110, and conversation input field 810 displays text 1020 in Conversational Interface 120 that reflects the selected element “Ask about section Hero”.

ICAI 100 supports multiple ways for editing an interface element. In one approach, the user may click or tap on an element directly within Visual Interface 110 and interact with Conversational Interface 120 to provide instructions or guidance regarding that element. In another approach, the user may select the active context through Conversational Interface 120 using a context indicator displayed in the chat panel. Alternatively, the user may provide general natural language instructions, such as “change the image of the man with glasses to a woman,” and ICAI 100 may automatically extract the relevant context and target elements based on the user input.

Using Visual Interface 110 for selecting elements (e.g., by clicking on them) may often provide a clear context for any editing system to function. In some embodiments, the combination of Visual Interface 110 and Conversational Interface 120, together with Context Recognition Module 130 and Interface Assistant 140, may resolve cases where Conversational Interface 120 does not provide a clear context on its own. Context Recognition Module 130 and Interface Assistant 140 may use information from multiple sources including, but not limited to, user input from both interfaces, the site structure, and the user's editing history to determine the current context.

Cases of ambiguous or unclear context may arise when a user provides a chat command without an explicit selection of the target component, such as instructing the system to “make the button red” while no button has been selected. In such situations, ICAI 100 may analyze the current page, section, or surrounding elements to determine the most likely relevant component or components, and when multiple candidates exist, may interact with the user via Conversational Interface 120 and pop-up prompts, or employ other mechanisms to resolve the ambiguity.

Ambiguity may also occur when the user selects multiple components of a relevant type in Visual Interface 110 but provides a command intended for a single component, or when the user selects one or more components and issues a command suitable only for some or none of the selected components, such as selecting text buttons and requesting a change to image resolution.

Similarly, ambiguity can arise when the user specifies a particular number of components in a command, such as “make the two text fields have the same size,” but the number of currently selected components does not match the instruction, or when the selected component(s) differ slightly from the intended type, in which case a modified version of the command may be applicable. ICAI 100 may, in these circumstances, propose an adapted command or adjust the component type to match the instruction, for example applying a command intended for a gallery type X to a gallery type Y if feasible.

Additionally, when a user performs a sequence of operations on one component and subsequently shifts focus to another component, ICAI 100 may suggest applying a parallel sequence of operations to the newly focused component, which may be identical or modified as appropriate. In all such cases, ICAI 100 may use the determined context to automatically select the applicable components, effectively activating them as if the user had previously selected them, thereby facilitating accurate and context-aware execution of commands.

Embodiments of ICAI 100 provide improved accuracy and efficiency in editing by maintaining clear awareness of the active context, thereby reducing misunderstandings and errors that commonly arise when users attempt to communicate their intentions through conventional conversational interfaces. ICAI 100 enhances context recognition and enables faster and more precise modifications with less iterative correction. ICAI 100 further provides improved user experience through visual cues and synchronized context handling, which allow users to confidently make changes knowing that the system accurately identifies the intended elements. In addition, ICAI 100 offers flexibility in interaction methods, permitting users to define context either through direct interaction with the interface or via natural language instructions, thereby accommodating diverse working styles and user preferences.

The disclosed ICAI 100 system provides several technical improvements over conventional interface editing approaches. In particular ICAI 100 reduces interaction overhead by minimizing the number of explicit selection actions required during editing. Conventional visual editors typically require users to select elements manually, such as by clicking or tapping, which can be cumbersome for operations involving multiple elements or dense interfaces. In contrast, the disclosed system enables users to specify context through natural language, allowing target elements to be identified by descriptive instructions rather than by manual selection.

ICAI 100 further infers likely target elements based on interaction history, semantic similarity analysis, and other contextual cues, reducing the need for repeated explicit selections. Moreover, ICAI 100 maintains context across multiple related editing operations, obviating the need to re-select elements for subsequent operation. In some embodiments, this approach may reduce the average number of user interactions required for selected editing tasks relative to traditional click-based selection methods.

The disclosed system also improves context accuracy by combining multiple input modalities. Rather than relying on a single input type, such as visual selection or textual commands alone, ICAI 100 integrates visual selection data, natural language semantic content describing element types and properties, spatial relationships such as proximity and containment, and temporal interaction patterns including recent user actions. By combining these signals, ICAI 100 achieves a more precise and robust understanding of the active editing context, even in complex or ambiguous scenarios.

In addition, ICAI 100 may maintain real-time (or close to real-time) synchronization of context across multiple interface components, including the visual editor, the conversational interface, and internal context management data structures. Visual indicators may be updated responsively as users hover over, select, or otherwise interact with elements, and the conversational interface may display the current context with reduced delay. In some embodiments, such synchronization is enabled through an event-driven architecture in which context changes trigger updates to dependent modules, which may reduce reliance on periodic polling or refresh cycles.

The technical architecture of ICAI 100 further provides implementation efficiencies. A modular design separates concerns such as context recognition, visual indication, AI processing, and operation execution, enabling independent optimization and testing of the modules. Frequently accessed context data, including element properties and interaction history, may be cached in memory for rapid retrieval, reducing database query overhead. Context Recognition Module 130 and LLM 145 queries may be executed asynchronously to reduce blocking of the user interface and help maintaining responsiveness. Finally, visual indicators are updated incrementally, such that only changed elements are re-rendered, reducing rendering overhead and improving overall system performance.

In one embodiment ICAI 100 may provide a context-aware artificial intelligence system for editing interface elements in a site and includes a visual interface configured to receive user operations on interface elements and present visual output, a conversational interface configured to receive natural language input and provide natural language output, a context recognition module configured to identify a plurality of candidate interface elements within a scope and compute respective relevance scores for the candidate interface elements based at least on semantic similarity between the natural language input and element metadata associated with the candidate interface elements, an interface assistant configured to determine one or more planned editing operations for a target interface element selected based on the relevance scores, a visual reaction module configured, responsive to an ambiguity condition among the candidate interface elements, to cause the visual interface to highlight at least two candidate interface elements and a conversational reaction module configured, responsive to the ambiguity condition, to cause the conversational interface to present a clarification prompt where the interface assistant is configured to apply the planned editing operations to the target interface element responsive to a user clarification input received via the conversational interface.

In one embodiment ICAI 100 a context-aware artificial intelligence system for editing interface elements in a site, The system includes a visual interface configured to receive user operations on interface elements and present visual output, a conversational interface configured to receive natural language input and provide natural language output, a context management module configured to maintain an active editing context identifying at least one active interface element across a plurality of user interactions and to update the active editing context responsive to a user operation received via the visual interface or a natural language input received via the conversational interface, a context recognition module configured to compute a relevance score based at least on semantic similarity between the natural language input and element metadata, and to select at least one active interface element for the active editing context based on the relevance score, an interface assistant configured to determine one or more planned editing operations based at least on the natural language input and the active editing context, a visual reaction module configured to cause the visual interface to present a visual indication associated with the at least one active interface element and a conversational reaction module configured to cause the conversational interface to present a context indicator identifying the at least one active interface element, wherein the visual indication and the context indicator are updated in synchronization responsive to updates to the active editing context.

In one embodiment ICAI 100 may provide a context-aware artificial intelligence system for editing interface elements in a site. The system includes a visual interface configured to receive user operations on interface elements and present visual output, a conversational interface configured to receive natural language input and provide natural language output, a context recognition module configured to identify a target interface element by computing relevance scores based at least on semantic similarity between the natural language input and element metadata, an interface assistant configured to generate one or more planned editing operations for the target interface element, a visual reaction module configured to cause the visual interface to present visual output corresponding to execution of the planned editing operations and a conversational reaction module configured to cause the conversational interface to present natural language output corresponding to the planned editing operations wherein the interface assistant comprises a response handler configured to validate at least one of an operation identifier or operation parameters associated with the planned editing operations against a supported operation set and constraints and verify existence of referenced interface elements within an active scope, request user confirmation prior to execution when a validation result indicates uncertainty or when an operation is destructive, and store a snapshot of an affected interface state prior to executing at least one planned editing operation and perform rollback to the snapshot responsive to an error or withdrawal of user confirmation.

In one embodiment ICAI 100 may provide a context-aware artificial intelligence system for editing interface elements in a site. The system includes a visual interface configured to receive user operations on interface elements and present visual output, a conversational interface configured to receive natural language input and provide natural language output, a context recognition module configured to determine context data associated with at least one candidate interface element, an interface assistant configured to obtain, from an artificial intelligence model responsive to the natural language input and the context data, a machine-readable response specifying at least an operation identifier and operation parameters for editing an interface element, a visual reaction module configured to cause the visual interface to present visual output corresponding to execution of the operation, and a conversational reaction module configured to cause the conversational interface to present natural language output corresponding to the operation where the interface assistant includes a response handler configured to parse the machine-readable response and validate the operation identifier and the operation parameters, verify that a target interface element referenced by the machine-readable response exists within an active scope, request user confirmation prior to execution responsive to a low-confidence condition, a failed validation condition, or a destructive-operation condition, and store a snapshot of an affected interface state and perform rollback to the snapshot responsive to an execution error or withdrawal of user confirmation.

In one embodiment ICAI 100 may provide a context-aware artificial intelligence system for editing interface elements in a site, the system includes a visual interface configured to receive user operations on interface elements and present visual output, a conversational interface configured to receive natural language input and provide natural language output, a context management module configured to maintain an active editing context and to generate a context change event responsive to an update to the active editing context, a context recognition module configured to compute relevance scores based at least on semantic similarity between the natural language input and element metadata and to update the active editing context based on the relevance scores, an interface assistant configured to determine one or more planned editing operations based at least on the natural language input and the active editing context, a visual reaction module configured to cause the visual interface to present a visual indication corresponding to the active editing context and a conversational reaction module configured to cause the conversational interface to present a context indicator corresponding to the active editing context, wherein the visual reaction module and the conversational reaction module are configured to update the visual indication and the context indicator responsive to the context change event.

In one embodiment the visual reaction module is configured to adapt at least one visual indicator responsive to an accessibility setting associated with a client device.

In one embodiment the system is configured to generate an announcement for an assistive technology interface when an active editing context changes, the announcement identifying a newly active element.

In one embodiment the system is configured to enable keyboard navigation among a plurality of elements in an active editing context and to update a visual indicator responsive to keyboard navigation input.

In one embodiment the visual interface includes a virtual reality interface or an augmented reality interface, and the visual reaction module is configured to render a three-dimensional context indicator associated with an active element.

In one embodiment the system is configured to output at least a spatial audio cue or haptic feedback, responsive to a change in the active editing context

In one embodiment the context recognition module is configured to infer the active interface element at least in part based on gaze tracking data.

In one embodiment the visual reaction module is configured to apply one or more cascading style sheet (CSS) classes to one or more DOM elements corresponding to an active editing context.

In one embodiment the system includes a client-side event-driven module configured to receive context change events and remove an indicator class from a first element and apply an indicator class to a second element.

In one embodiment the visual reaction module is configured to render a visual indicator using an overlay layer that is separate from an underlying user interface element.

In one embodiment the context recognition module is configured to receive a user-defined context definition associated with a page, template, or section, and to adjust at least one relevance score responsive to the user-defined context definition.

In one embodiment the system is configured to operate in a collaborative editing session among a plurality of users and to transmit a context change event associated with a first user to a client device of a second user.

In one embodiment the visual interface of the second user is configured to display an indicator corresponding to the active editing context of the first user.

In one embodiment the response handler is configured to store a snapshot of an affected interface state prior to applying the planned editing operation and to perform rollback to the snapshot responsive to a detected error, a failed validation, or withdrawal of user confirmation.

In one embodiment the system may trigger a disambiguation criterion when a plurality of candidate interface elements have relevance scores within a tolerance of a maximum relevance score.

For example, when the user enters the command “Make the button red” into the conversational interface, and the system identifies three buttons A, B, and C on the page with relevance scores of 0.85, 0.83, and 0.45, respectively, and when a tolerance threshold of 0.05 is applied relative to the maximum score of 0.85, both Button A (0.85) and Button B (0.83) fall within the tolerance range. Accordingly, the system may initiate a disambiguation process because two buttons have similarly high relevance scores.

In one embodiment a structured representation of the site includes a document object model (DOM) representation or a view hierarchy representation, and at least one planned editing operation includes modifying the structured representation.

In one embodiment the relevance scores are based proximity to a previously selected interface element, interaction recency, or visual prominence.

In one embodiment the context management module generates a context change event, and the visual reaction module and the conversational reaction module update a visual indication and a context indicator responsive to the context change event.

In one embodiment the ICAI 100 may provide a context-aware artificial intelligence system for editing interface elements of a site. The system includes a visual interface configured to present the site and receive user interaction with interface elements, a conversational interface configured to receive a natural-language instruction and output natural-language messages, a context recognition module configured to identify candidate interface elements within a scope and compute respective relevance scores using semantic similarity between the instruction and metadata of relevant candidates, and an interface assistant configured to detect an ambiguity condition in which at least two candidates satisfy a disambiguation criterion, cause the visual interface to highlight the at least two candidates and cause the conversational interface to present a clarification prompt, and responsive to a user clarification input, select a target element and apply one or more editing operations to the target element.

In one embodiment, the ICAI 100 may provide a context-aware AI system for editing interface elements of a site. The system includes a visual interface and a conversational interface, a context management module maintaining an active editing context identifying at least one active interface element, updated responsive to a visual selection or a natural-language instruction, a context recognition module scoring candidate elements using semantic similarity between the instruction and candidate metadata and selecting the active interface element, an interface assistant generating one or more editing operations based on the instruction and the active editing context, and visual and conversational reaction modules displaying, respectively, a visual indication and a context indicator for the active interface element where the visual indication and the context indicator are updated in synchronization when the active editing context changes.

In one embodiment the ICAI 100 may provide a context-aware AI system or editing interface elements of a site. The system includes a visual interface and a conversational interface, a context recognition module configured to select a target element by scoring candidate elements using semantic similarity between a natural-language instruction and candidate metadata, an interface assistant configured to generate one or more editing operations for the target element, visual and conversational reaction modules configured to present results of the editing operations; and a response handler configured to, before executing an editing operation, validate an operation identifier and parameters, validate that the referenced elements exist within an active scope, request user confirmation for a low-confidence, failed-validation, or destructive operation, and store a snapshot of affected interface state and rollback responsive to an error or withdrawn confirmation.

In one embodiment, the ICAI 100 may provide a context-aware AI system for editing interface elements of a site. The system includes, a visual interface and a conversational interfaces, a context recognition module configured to determine context data for at least one candidate interface element, an interface assistant configured to provide the context data and a natural-language instruction to an AI model and to receive a machine-readable response specifying an operation identifier and operation parameters and a response handler configured to parse and validate the response, verify that a referenced target element exists within an active scope, store a snapshot of interface state, request user confirmation for a low-confidence, failed-validation, or destructive operation, execute the operation responsive to confirmation, and rollback to the snapshot responsive to an execution error or withdrawn confirmation, where the visual interface and the conversational interface are updated based on execution of the operation.

In one embodiment, the ICAI 100 may provide a context-aware AI system for editing interface elements of a site. The system includes a visual interface and a conversational interface, a context management module configured to maintain an active editing context and generate a context change event when the active editing context is updated, a context recognition module configured to compute relevance scores for candidate elements using semantic similarity between a natural-language instruction and candidate metadata and to update the active editing context based on the relevance scores, an interface assistant configured to determine one or more editing operations based on the instruction and the active editing context, and visual and conversational reaction modules configured to, responsive to the context change event, update a visual indication in the visual interface and a context indicator in the conversational interface that correspond to the active editing context. The following description provides exemplary implementation details intended to illustrate certain embodiments. These examples are not intended to limit the scope of the invention, but rather to assist in understanding possible ways in which the disclosed systems and methods may be implemented.

The detailed embodiments described herein include examples implemented in a website building system provided by Wix.com, Ltd. However, the disclosed techniques are not limited to this specific implementation. The context-aware AI system such as ICAI 100 can be deployed in any visual editing environment, including but not limited to: Website builders and content management systems from any provider; Web development integrated development environments (IDEs); Mobile app development platforms; Desktop application design tools; Game development engines; 3D modeling and computer-aided design (CAD) software; VR/AR content creation tools; Document and presentation editors and any other visual editing or design software.

Where figures or examples show specific branding or product names, these are provided solely for illustration and do not limit the scope of the disclosed techniques. ICAI 100 can be adapted to any editing platform with appropriate modifications to account for platform-specific interface structures, APIs, and user interaction patterns.

The following examples illustrate representative implementations for common operations performed by ICAI 100.
Context Recognition Module—sample implementation
Data Structures:
The system maintains a context data structure comprising:
scope_type: an enumeration indicating page-level, section-level, container-level, or element-level scope.
scope_id: a unique identifier for the current scope.
candidate_elements: an array of interface element objects, an entry in the array containing:
element_id: a unique identifier;
element_type: a classification (e.g., button, image, text field, container);
dom_path: a hierarchical path within a document structure;
visual_coordinates: position and dimensions;
metadata: attributes, styles, and content preview;
interaction_history: timestamps and types of recent user interactions.
confidence_scores: an array of numerical values (e.g., between 0.0 and 1.0) corresponding to each candidate element.
selection_history: an ordered list of previously selected elements with timestamps.

Algorithm Steps:

When a user provides a natural language instruction U (for example, “make the button red”) and the system has knowledge of currently selected elements S (which may be empty), the algorithm may proceed as follows.

Step 1: Input Parsing

The system parses the instruction U using natural language processing to extract:
(i) a target_element_type (for example, “button”);
(ii) a modification_type (for example, “color change”);
(iii) modification_parameters (for example, “red”);
(iv) quantifiers (for example, “the”, “all”, “two”, “specific”).

Step 2: Scope Determination
If S is non-empty, the system may set the scope to the smallest common container of elements in S. If S is empty, the system may set the scope based on the user's current view or the most recently interacted section. The system then queries the interface structure to identify all elements within the scope that match the target_element_type.

Step 3: Relevance Scoring

For each candidate element E in the identified scope, the system computes a relevance score R(E) as a weighted combination:

R(E)=w1×semantic_similarity(U, E)+w2×proximity_score(E, S)+w3×interaction_recency(E)+w4×visual_prominence(E)

where, in one embodiment:
(i) semantic_similarity(U, E) is computed by encoding the instruction U and element metadata (type, attributes, contained text) using a language model (for example, a transformer-based model) and calculating a similarity score (such as cosine similarity) between the resulting embeddings. In some embodiments, the similarity score is scaled or normalized (e.g., to a 0-1 range) for use with thresholds. As used herein, “element metadata” may include one or more of: element type, element identifier, contained text, attributes, style properties, structural location (e.g., DOM path or hierarchy position), and other properties associated with an interface element.
(ii) proximity_score(E, S) is based on spatial or structural proximity between E and any elements in S. For example, proximity_score(E, S) may be computed as an inverse function of the DOM distance d between E and the nearest element in S, such as 1/(1+d), to avoid division-by-zero. When S is empty, proximity_score(E, S) may be set to 0, omitted from R(E) (with weights renormalized), and/or computed relative to a most recently interacted element or the user's current view; (iii) interaction_recency(E) is a function of the time since the user last interacted with E, for example exp(−λ×t), where t is elapsed time and λ is a decay constant;
(iv) visual_prominence(E) is computed from element size, position, and ordering (for example, larger or centrally positioned elements may be assigned higher scores).

In some embodiments, component score used in R(E) (semantic_similarity, proximity_score, interaction_recency, visual_prominence) is normalized or scaled to a common range prior to weighting, such that threshold T and tolerance δ are applied on a consistent scale.

In one implementation, default weights may be w1=0.4, w2=0.3, w3=0.2, and w4=0.1, although alternative embodiments may use different weights, additional scoring factors, or a trained model to generate relevance scores.

Step 4: Context Selection

The system may identify the element or elements with the highest relevance scores. If the maximum score (e.g., after normalization/scaling) exceeds a threshold T (for example, T =0.7), the system selects that element as the active context. If multiple elements have scores within a tolerance δ (for example, δ=0.1) of the maximum and the instruction includes quantifiers suggesting multiple targets, the system may select all such elements as the active context.

If no element exceeds the threshold T, or if multiple elements have similar high scores but the instruction suggests a single target, the system may initiate a disambiguation process.

Step 5: Disambiguation Process

When disambiguation is required, the system may:
(i) generate visual indications highlighting a subset of candidate elements with highest relevance scores;
(ii) present a prompt through the Conversational Interface requesting clarification (for example, indicating key differences between candidates);
(iii) update the context based on the user's clarifying input.

Step 6: Context Update and Storage
The system updates the context data structure with the selected element or elements, adds the selection to the selection_history with a timestamp, triggers Visual Reaction Module 160 to highlight the selected element or elements, and passes context information to Interface Assistant 140 for generating appropriate editing operations.

Alternative Implementations:

In alternative embodiments, the Context Recognition Algorithm may employ different approaches, including but not limited to:
(i) Computer vision-based recognition, in which a rendered image of the interface is processed to identify visual regions corresponding to interface elements, which are then mapped back to underlying interface structures.
(ii) Machine learning-based scoring, in which a trained model receives feature vectors representing candidate elements and the user instruction and outputs relevance scores learned from historical interaction data.
(iii) Rule-based context inference, in which explicit rules handle common scenarios (for example, selecting an element when the instruction includes a unique identifier present in only one element, or applying spatial rules such as “the button on the left”).
(iv) Hybrid approaches that combine rules and learned models, such as using rules for high-confidence scenarios and ML-based scoring for ambiguous cases.

Handling Ambiguous or Unclear Context:

The system can address various scenarios in which context may be ambiguous, such as:
(i) no prior selection and ambiguous instruction;
(ii) multiple selected elements with an instruction applicable to only a subset;
(iii) discrepancies between the number of elements referenced in the instruction and the number selected;
(iv) instructions that refer to an element type different from the currently selected elements;
(v) patterns in interaction history indicating that certain elements are likely targets of subsequent instructions.

Thresholds and Parameters:

Parameters such as the relevance threshold T, similarity tolerance δ, decay constant λ, the number of disambiguation candidates, and weights w1-w4 may be adjusted by configuration or learned from user feedback in order to optimize performance for particular deployment environments or user populations.

The disclosed system is in the realm of website systems (WBS) design and analysis, though it may be applied in other types of visual editing systems and additional situations and embodiments. In one embodiment, the disclosure is directed to web interface editing systems, particularly to a context-aware artificial intelligence system for assisting users in editing web elements through visual and conversational interfaces. The inventive system may be implemented in systems other than WBS, including those used to create applications in multiple technologies (such as mobile apps or various apps and plug-ins embedded in larger systems).

Although the detailed embodiments described herein frequently reference web interface editing and website building systems for illustrative purposes, the disclosed techniques are not limited to web-based contexts. The term “interface editing” as used herein encompasses editing of any visual user interface, including without limitation a Web-based interfaces (websites, web applications, browser-based tools); native mobile application interfaces (ios, Android, cross-platform mobile apps); desktop application interfaces (Windows, MacOS, Linux applications); game user interfaces and heads-up display (HUD) elements; 3D modeling and computer-aided design (CAD) system interfaces; virtual reality (VR) environment interfaces; augmented reality (AR) overlay interfaces; document editing interfaces (word processors, presentation software, spreadsheets); video editing software interfaces'Graphic design and illustration tool interfaces; database and data visualization tool interfaces and any other system involving visual manipulation of interface elements or graphical objects

Similarly, the term “element” or “interface element” as used herein refers to any discrete component of a visual interface, including without limitation: buttons, text fields, images, containers, sections, panels, windows, dialogs, menus, 3D objects, document elements, timeline clips, layers, shapes, chart components, and any other selectable or editable component of a visual interface.

Where specific examples reference web technologies (e.g., DOM, HyperText Markup Language (HTML), CSS, JavaScript), analogous technologies exist in other domains (e.g., view hierarchies in mobile apps, scene graphs in 3D environments, document object models in word processors), and the disclosed techniques apply equally to such analogous technologies with appropriate adaptations.

Unless specifically stated otherwise, as apparent from the preceding discussions, it is appreciated that, throughout the specification, discussions utilizing terms such as “analyzing,” “generating,” “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

The inventive elements discussed hereinabove may be implemented on a suitable apparatus. This apparatus may be specially constructed for the desired purposes, or it may comprise a computing device or system typically having at least one processor and at least one memory, selectively activated or reconfigured by a computer program, code or prompt. The resultant apparatus when instructed by program, code or prompt may turn the general-purpose computer into inventive elements as discussed herein. The program, code or prompt may define the inventive device in operation with the computer platform for which it is desired. Such program, code or prompt may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing programs, code or prompts. The computer readable storage medium may also be implemented in cloud storage.

Some general-purpose computers may comprise at least one communication element to enable communication with a data network and/or a mobile communications network.

An AI agent can be considered a software-implemented computational entity configured to autonomously perceive input data from its environment (including digital, physical, or simulated domains), process the data using one or more machine learning, rule-based, statistical, or symbolic reasoning techniques, and execute goal-directed actions or generate outputs in response to the data.

The AI agent may operate continuously or in discrete instances, may learn from historical or real-time inputs, and may update its internal models or policies dynamically. The agent can be embodied in standalone software, embedded systems, distributed cloud environments, or hardware-integrated systems, and may include components such as inference engines, training subsystems, decision-making modules, and interaction interfaces (e.g., via natural language, API, sensors, or actuators).

The system may employ tools that aid website-building systems in automating design generation, UI understanding, image-to-code translation, stack analysis, optimization, personalization, and deployment. The system may combine multiple interoperable engines from these and related domains: (i) design automation using generative models (generative adversarial networks (GANs), variational autoencoders (VAEs), diffusion, autoregressive layout, neural style transfer, evolutionary search, constraint solving, Bayesian optimization); (ii) UI understanding from screenshots/mockups (object detection, segmentation, optical character recognition (OCR), keypoint detection, embeddings, anomaly detection); (iii) image-to-code translation (skeleton HTML/CSS/JS, DOM-like hierarchies, detectable constraints); (iv) code/stack modeling (abstract syntax tree (AST)/control flow graph (CFG) graphs, embeddings, risk scoring, dependency analysis, clone detection); (v) reinforcement learning-based optimization and personalization (bandits, deep reinforcement learning (RL), offline RL); (vi) recommendations and content adaptation (matrix factorization, deep recommenders, session models, graph recommenders, topic models, computer vision (CV)-based signals); (vii) knowledge-based and neuro-symbolic governance (rule engines, knowledge graphs, planning, validation against design-system constraints); and (viii) emergent full-stack patterns (multimodal foundation models, agentic pipelines, diffusion with constraints, DOM/component graph representations, on-device models). The modules may cooperatively provide end-to-end design-to-deploy capability for website building ecosystems. The foregoing engines and tools are described as optional interoperable components that may be external to ICAI 100 and are not required for operation of the context-aware editing workflows described herein.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A context-aware artificial intelligence (AI) system for editing visual interface elements of a site, the system comprising:
at least one memory storing instructions;
at least one processor communicatively coupled to said memory;
a visual interface configured to support presentation of said visual interface elements, reception of user interaction, and presentation of visual output;
a conversational interface configured to support reception of one or more natural language instructions, and presentation of one or more natural language messages;
a context recognition module configured to identify a plurality of interface elements within a scope of said site, compute a respective score for each of the plurality of interface elements based at least on semantic similarity between said one or more natural language instructions and metadata associated with each of said plurality of interface elements, and select one or more candidate interface elements having respective scores that satisfy a configurable selection criterion;
a context management module configured to maintain an active editing context identifying at least one candidate interface element and context data associated with said at least one candidate interface element, and to update said active editing context in response to a visual operation received via said visual interface or in response to natural language instructions received via said conversational interface;
an interface assistant configured to generate one or more planned editing operations related to said active editing context based on said one or more natural language instructions;
a visual reaction module configured to apply said one or more planned editing operations to modify at least one visual interface element of said site and to display a visual indication associated with said active editing context on said visual interface; and
a conversational reaction module configured to display one or more conversational natural language messages on said conversational interface;
wherein said visual interface, said conversational interface, said context recognition module, said context management module, said interface assistant, said visual reaction module and said conversational reaction module comprise instructions stored in said at least one memory and executable by said at least one processor.

2. The system of claim 1, further comprising one or more large language models (LLMs) configured to generate at least part of said one or more planned editing operations responsive to prompts generated based on said one or more natural language instructions and at least one of: an active editing context or context data, wherein said one or more LLMs are pretrained, trained offline, or both, and wherein data for training said one or more LLMs is derived from one or more of: (i) interaction data captured during one or more editing sessions of said user, including a current editing session, and stored for subsequent offline training; (ii) a plurality of editing sessions of said user across multiple sites; and (iii) a plurality of editing sessions of multiple users.

3. The system of claim 2, wherein said interface assistant further comprises:
a prompt generator configured to construct said prompts for said one or more LLMs, said prompt being constructed to elicit a response indicative of one or more candidate interface elements and one or more associated actions or selectable options; and
a response handler configured to receive a response from said one or more LLMs and to:
validate that an operation identifier in said response corresponds to a supported set of available operations and that associated parameters conform to expected data types, value ranges, and constraints;
verify that any interface element referenced by said response exist within an active editing context; and
responsive to (a) a validation result indicating uncertainty or (b) a destructive operation, request user confirmation prior to-executing said one or more planned editing operations.

4. The system of claim 3, wherein said prompt generator utilizes any combination of: user interaction data comprising user input, user interaction history and user feedback; page and context data comprising said at least one active interface element, said scope and a structured representation of a page of said site; and visual and structural data comprising visual information and capabilities and properties of interface elements, for generating said prompt.

5. The system of claim 1, wherein said context recognition module further comprises:
a current user interaction analyzer configured to infer an editing context based on interactions of said user with said visual interface and said conversational interface;
a historical user interaction analyzer configured to infer an editing context based on historical interaction data of said user;
a site information extraction module configured to infer an editing context based on a structure and content of a web page of said site; and
a context prioritization module configured to evaluate one or more inferred contexts according to their relevance to said user.

6. The system of claim 5, wherein said current user interaction analyzer further comprises:
a graphical selection module configured to analyze user interactions with said visual interface and to identify a first set of interface elements selected by said user; and
a chat information extraction module configured to analyze said one or more natural language instructions and to identify a second set of interface elements referenced by said one or more natural language instructions.

7. The system of claim 5, wherein said historical user interaction analyzer further comprises:
a current site editing history module configured to analyze historical editing interactions of said user with said site across prior editing sessions;
other sites' editing history module configured to analyze historical editing interactions of said user with one or more other sites; and
a common interaction patterns module configured to identify common interaction patterns of multiple users editing a plurality of sites.

8. The system of claim 1, further comprising a user feedback module configured to collect feedback associated with system-generated natural language output from said user, and wherein said interface assistant is further configured to utilize said feedback to determine or refine one or more planned editing operations.

9. The system of claim 1, wherein said visual interface is further configured to apply one or more visual indicators to visually distinguish selected interface elements, said visual indicators comprising one or more of: border highlighting, background overlay, glow effects, annotation labels and dimming of surrounding elements.

10. The system of claim 1, wherein:
responsive to a selection of an interface element made by said user through said conversational interface, said visual interface is configured to apply a visual indicator to selected interface element; and
responsive to a selection of an interface element made by said user through said visual interface, said conversational interface is configured to apply a corresponding indicator to a representation of the selected interface element.

11. A method for editing visual interface elements of a site, the method comprising:
supporting presentation of said visual interface elements in a visual interface, reception of user interaction, and presentation of visual output;
supporting reception of one or more natural language instructions in a conversational interface and presentation of one or more natural language messages;
identifying a plurality of interface elements within a scope of said site and computing a respective score for each of the plurality of interface elements based at least on semantic similarity between said one or more natural language instructions and metadata associated with each of said plurality of interface elements, and selecting one or more candidate interface elements having respective scores that satisfy a configurable selection criterion;
maintaining an active editing context identifying at least one candidate interface element and context data associated with said at least one candidate interface element, and updating said active editing context in response to a visual operation received via said visual interface or in response to natural language instructions received via said conversational interface;
generating one or more planned editing operations related to said active editing context based on said one or more natural language instructions;
applying said one or more planned editing operations to modify at least one visual interface element of the site and displaying a visual indication associated with said active editing context on said visual interface; and
displaying one or more conversational natural language messages on said conversational interface.

12. The method of claim 11, further comprising generating prompts based on said one or more natural language instructions and at least one of: an active editing context or context data, and providing said prompts to one or more large language models (LLMs), wherein said one or more LLMs are pretrained, trained offline, or both, and wherein data for training said one or more LLMs is derived from one or more of: (i) interaction data captured during one or more editing sessions of said user, including a current editing session, and stored for subsequent offline training; (ii) a plurality of editing sessions of said user across multiple sites; and (iii) a plurality of editing sessions of multiple users.

13. The method of claim 12, wherein said step of generating prompts further comprises:
constructing said prompts for said one or more LLMs to elicit a response indicative of one or more candidate interface elements and one or more associated actions or selectable options;
receiving a response from said one or more LLMs;
validating that an operation identifier in said response corresponds to a supported set of available operations and that associated parameters conform to expected data types, value ranges, and constraints;
verifying that any interface element referenced by said response exists within an active editing context; and
requesting user confirmation prior to executing said one or more planned editing operations if a validation result indicates uncertainty or an existence of a destructive operation.

14. The method of claim 13, further comprising generating said prompt by utilizing any combination of: user interaction data that comprises user input, user interaction history and user feedback; page and context data that comprises said at least one active interface element, said scope and a structured representation of a page of said site; and visual and structural data that comprises visual information, capabilities and properties of interface elements.

15. The method of claim 11 further comprising inferring an editing context based on
interactions of said user with said visual interface and said conversational interface;
historical interaction data of said user;
a structure and content of a web page of said site; and
relevance to said user.

16. The method of claim 15 further comprises:
analyzing user interactions with said visual interface using a graphical selection and identifying a first set of interface elements selected by said user; and
analyzing said one or more natural language instructions and identifying a second set of interface elements referenced by said one or more natural language instructions.

17. The method of claim 15, wherein inferring an editing context based on historical interaction data comprises:
analyzing historical editing interactions of said user with said site across prior editing sessions;
analyzing historical editing interactions of said user with one or more other sites; and
identifying common interaction patterns of multiple users editing a plurality of sites.

18. The method of claim 11 further comprising collecting feedback associated with system-generated natural language output from said user, and utilizing said feedback to determine or refine one or more planned editing operations.

19. The method of claim 11 further comprising applying one or more visual indicators to visually distinguish selected interface elements, said visual indicators comprising one or more of: border highlighting, background overlay, glow effects, annotation labels and dimming of surrounding elements.

20. The method of claim 11, wherein:
applying a visual indicator to selected interface element in said visual interface in response to a selection of an interface element made by said user through said conversational interface; and
applying a corresponding indicator to a representation of said selected interface element in said conversational interface in response to a selection of an interface element made by said user through said visual interface.
